(19) United States
(12) Patent Application Publication
(10) Pub. No.: US 2010/0330349 A1
(43) Pub. Date: Dec. 30, 2010

(54) Component

(75) Inventors: Kurt Ewald, Frankenthal (DE); Christian Geubert, Zwingenberg (DE); Jan Helms, Budapest (HU); Peter Kritzer, Forst (DE); Thorsten Wieland, Dossenheim (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: CARL FREUDENBERG KG, Weinheim (DE)

(21) Appl. No.: 12/919,526

(22) PCT Filed: Feb. 27, 2009
(86) PCT No.: PCT/EP2009/001393

§ 371 Date: Aug. 26, 2010

(30) Foreign Application Priority Data
Feb. 29, 2008 (EP) 08003832.6

(51) Int. Cl. B32B 3/10

(52) U.S. Cl. 428/203; 428/195.1; 428/201

(57) ABSTRACT

A component includes at least one element made of a sealing material, wherein a topographic marking is incorporated into the at least one element,

### CROSS REFERENCE TO PRIOR APPLICATIONS

This application is a U.S. National Phase application under 35 U.S.C. §371 of International Application No. PCT/EP2009/001393, filed on Feb. 27, 2009 and claims benefit to European Application No. EP 08003832.6, filed on Feb. 29, 2008. The International Application was published on Sep. 3, 2009 as WO 2009/106334 under PCT Article 21 (2).

### FIELD

The invention relates to a component having an element made of elastomeric material, whereby the element is provided with a marking

### BACKGROUND

Such components are known from European patent application EP 1 354 304 B1. There, a method is described for marking components by applying a counterfeit-proof marking. For this purpose, a label is provided with detectable particles that are distributed in a random pattern on the label. These particles are detected by an optical system and stored, and they can be once again unambiguously associated by repeatedly reading them out. By way of an example, this application describes the marking of a tire by means of a label. When it comes to machine elements, the aspects of security against counterfeiting and the traceability of the production are becoming more and more important since, for example, counterfeit inferior-quality seals can wear out prematurely or not even provide the requisite sealing effect, thereby causing tremendous damage.

### SUMMARY OF THE INVENTION

An aspect of the present invention is based on applying a durable and counterfeit-proof marking on components with sealing materials.

In an embodiment, the element, which is made of a sealing material, is provided with a marking that is incorporated as a topographic marking into the element. Sealing materials as set forth in the invention are polymer materials with elastomeric or elastic properties. Such materials are, for example, rubber-like materials, elastomers, thermoplastic elastomers, thermoplastic polyurethanes or polytetrafluoroethylene. The marking that is incorporated as a topographic marking deep into the material of the element contains data in encoded form about the product, the manufacturer as well as additional information. The encoding allows the marking and counterfeit-proof identification of the component as well as an unambiguous association of the component with a manufacturer and also, if applicable, information about production batches. Thus, the marking forms an authenticity feature. Preferably, the marking is incorporated into the element by means of laser processing, since the laser marking is applied directly onto the component, thereby marking the actual material itself. The laser treatment removes material down to a preselected depth. As a result, it is not possible to remove the marking from the component without damaging the component. Furthermore, it is advantageous that the laser marking takes place contact-free, so no deformation of the component can occur with a resultant distortion of the marking Moreover, the marking is applied after the production of the finished product. Therefore, production data such as the date of manufacture and the batch number as well as other quality features can be subsequently applied as additional information onto the component. The laser marking is applied onto the surface, as a result of which it is very easy to apply and to detect. Moreover, no foreign matter is introduced into the component that could be released and cause undesired effects. The marking can be read out with relatively simple optical means. Particularly when compared to electronic identifiers such as, for example, integrated memory modules, optical marking by means of a laser is cost-effective and thus also suitable for inexpensive mass-produced components. The optical marking is especially well-suited for marking curved, three-dimensional surfaces. Conceivable components that can be provided with the marking according to the invention are, for example, radial shaft seal rings, O-rings, X-rings, quad rings, rubber bellows, membranes, hydraulic seals, pneumatic seals and similar components.

The marking can contain redundant information multiple times. Redundant means that the information is contained in the marking multiple times and in various forms. Thus, it is still possible to read out the marking, even if a large part of the marking has been destroyed, for example, by wear and tear.

The marking can be incorporated into a functional surface of the element. Particularly with sealing components, it is necessary to mark their non-metal constituent. Seals are often made of a composite consisting of sealing material and metal, whereby original metal parts can be re-used for counterfeit products. Therefore, it is not advantageous to mark the metal part but rather it is advantageous to mark the element made of sealing material, which is responsible and much more critical for the sealing function and which is more prone to wear and tear and, under some circumstances, to also mark the functional surface. Surprisingly, it was found that the function of a seal is not impaired if a functional surface is provided with a laser marking that is applied onto the surface and that causes removal of material. In particular, it was found that components marked according to the invention also meet high hygienic requirements and that no impermissible bacterial growth occurs in the marking. Seals marked in this manner can especially be configured as sealing rings having various cross sections, as radial shaft seal rings, flat seals or valve stem seals. Especially in the case of O-rings and similar sealing elements, it is advantageous to be able to incorporate the marking into a functional surface, since it is not possible to determine ahead of time which surface section will be essential for the sealing function once the O-rings have been installed.

The depth of the marking can be less than 100 μm, preferably less than 50 μm. Experiments have shown that markings can also be read whose depth is a mere 2 μm if the original surface roughness is below this value. However, in the case of such a slight depth, the legibility will diminish due to friction as the component ages, so that the markings of some components are no longer legible. As far as the legibility is concerned, it is advantageous when the depth of the marking is a deep as possible. However, some components of sealing components have developed a failure of the sealing function if the depth of the marking was more than 100 μm. An especially advantageous balance between the legibility and the sealing function is attained at a depth of less than 50 μm. If the sealing function is to meet stringent requirements or if unfavorable conditions prevail, then a depth of less than 25 μm is especially advantageous. It has also been found that the marking was still very legible, even after substantial swelling of the sealing material.

A layer can be arranged over the marking This layer can be non-opaque, that is to say, transparent, or else opaque, that is to say non-transparent. In the case of an opaque layer, the layer has to be thinner than the depth of the marking so as to ensure the legibility. Advantageously, the thickness of the layer is maximally 50% of the depth of the marking With a transparent layer, which can be made, for instance, of clear lacquer, it is also possible to first apply the layer and to subsequently apply the marking through the layer by means of a laser treatment. In this process, the layer remains virtually unchanged. Here it is advantageous that the marking is protected by the layer against outside influences. Thus, the layer is especially well-suited for applications that call for a high level of security in terms of the marking.

In an embodiment, the layer (5) is transparent.

In an embodiment, the laser treatment is carried out through the layer (5).

In an embodiment, the layer (5) is opaque.

The component can be configured as a composite component made of metal and an elastomeric constituent. In addition to the above-mentioned seals, it is also particularly possible to provide a marking on shock absorbers, hydromounts, uncoupling elements and similar components. With these components, it is also advantageous for the elastomeric part to be provided with a marking instead of the metal part, since, in contrast to the elastomeric part, the metal part is easy to re-use.

### BRIEF DESCRIPTION OF THE DRAWINGS

Several embodiments of the component according to the invention are explained in greater depth below with reference to the figures. The figures schematically show the following:

FIG. 1 a marked O-ring;

FIG. 2 a marked radial shaft seal ring.

### DETAILED DESCRIPTION

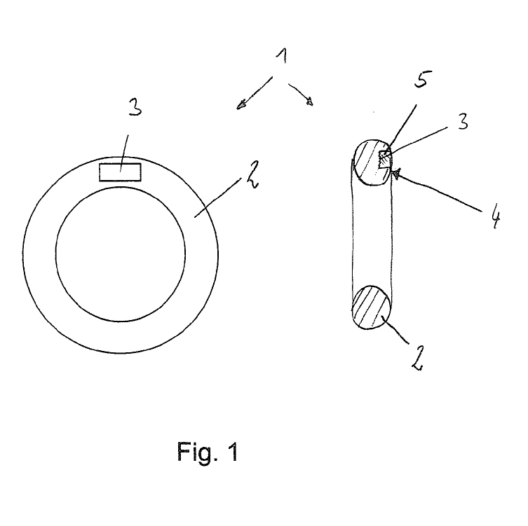

FIG. 1 shows a component 1, in this embodiment an O-ring, with an ring-shaped element 2, the base, made of elastomeric material. The element 2 is provided with a topographic marking 3 that has been made in the element by means of a laser treatment. The marking 3 contains information in counterfeit-proof, encoded form about the product, the manufacturer, the production location, the date of manufacture and the material employed. In addition, information about material properties and limitations on use can be incorporated there. The information is applied onto the component 1 multiple times in different forms, as a result of which the information is contained in the marking 3 multiple times and redundantly. In this embodiment, the depth of the marking 3 is 24 μm. Since the entire circumference of an O-ring can be used as a functional surface 4, the marking 3 is also made in the functional surface 4 of the element. The marking 3 is covered with a transparent layer 5, whereby the marking 3 was applied into the element 2 through the layer 5.

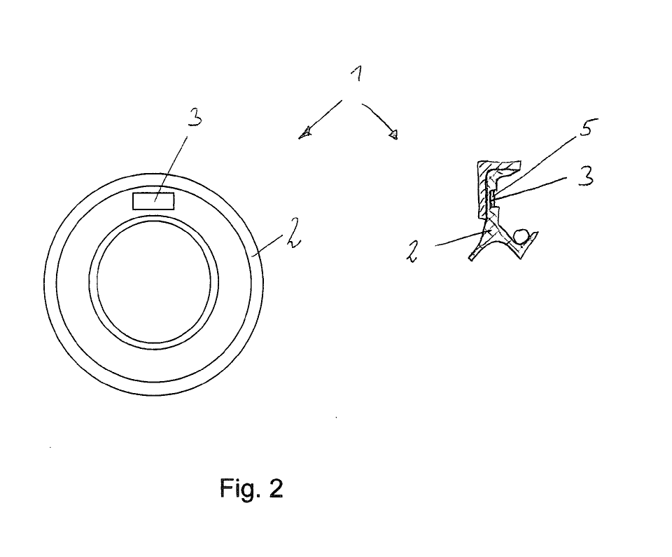

FIG. 2 shows a component 1, in this embodiment a radial shaft seal ring. The radial shaft seal ring consists of a carrier made of metal material and of a sealing lip that is applied onto the carrier. The sealing lip forms the element 2 which is made of elastomeric material. The sealing lip can also be made of other sealing materials such as, for example, PTFE. Therefore, the radial shaft seal ring is a component 1 configured as a composite part with metal. The topographic marking 3 is made in the elastomeric element 2, that is to say, the sealing lip, by means of a laser and it has a depth of 30 μm. The marking 3 contains information in counterfeit-proof, encoded form about the product, the manufacturer, the production location, the date of manufacture and the material employed. Here, the information is applied onto the component 1 multiple times in different forms, as a result of which the information is contained in the marking 3 multiple times and redundantly. In this context, the marking 3 can be applied onto the element 2 in such a way that it can also be recognized and read out after being installed. Consequently, the component 1 can always be checked without being destroyed in the process. The marking is provided with an opaque layer 5 whose thickness is about 50% of the depth of the marking 3.

1-12. (canceled)

13. A component comprising:
at least one element made of a sealing material, wherein a topographic marking is incorporated into the at least one element.

14. The component as recited in claim 11 wherein the marking is incorporated into the at least one element using laser processing.

15. The component as recited in claim 12, wherein the marking is configured as a code.

16. The component as recited in claim 12, wherein the marking includes redundant information multiple times.

17. The component as recited in claim 12, wherein the at least one element includes a functional surface, and wherein the marking is incorporated into the functional surface.

18. The component as recited in claim 12, wherein the marking has a depth of less than 100 μm.

19. The component as recited in claim 12, wherein the component is a composite part including a metal and an elastomeric constituent.

20. The component as recited in claim 12, wherein the component is at least one of a seal, an uncoupling element, a shock absorber, a bellows, a membrane, and a hydromount.

21. The component as recited in claim 12, wherein the at least one element includes a layer disposed over the marking.

22. The component as recited in claim 21, wherein the layer is transparent.

23. The component as recited in claim 22, wherein a laser treatment is configured to be performed through the layer.

24. The component as recited in claim 21, wherein the layer is opaque.
